(19) United States
(12) Patent Application Publication
(10) Pub. No.: US 2004/0061691 A1
(43) Pub. Date: Apr. 1, 2004

(54) Display module

(76) Inventors: Christian Gruber, Ingolstadt (DE); Sven Hayn, Horlkofen (DE)

Correspondence Address: BELL, BOYD & LLOYD, LLC, P. O. BOX 1135, CHICAGO, IL, 60690-1135, US

(21) Appl. No.: 10/468,494

(22) PCT Filed: Feb. 6, 2002
(86) PCT No.: PCT/DE02/00432

(30) Foreign Application Priority Data
Feb. 16, 2001 (DE) 101-07-437.9

(51) Int. Cl. G09G 5/00

(52) U.S. Cl. 345/204

(57) ABSTRACT

For cooling display module types, at least one decoupling resistor is placed in at least one connecting line extending between a display controller of the display module and an interface situated between the display controller and a unit.

The invention relates to a display module, in particular one which includes a display, a display controller, and connecting lines between the display controller and an interface to a unit and which can be used in particular as a component part of portable communication devices such as, for example, mobile telephones, portable devices in the area of entertainment electronics, or portable computers.

Rapid technical advances in the area of mobile communication have led to increasingly smaller and lighter mobile telephones over recent years. Yet a need for further miniaturization persists to this day. Moreover, as mobile telephone manufacturers are under cost pressure that is rising with increasing market saturation, the focus of development remains on designing simple mobile telephones fitted with a small number of components.

A display module generally consists of a display, a corresponding display controller for driving the display and of corresponding connecting lines between them, and connections from the display controller to an interface to a unit such as, for example, the chip set or the printed circuit board of a mobile telephone.

For connection to a type of unit or type of printed circuit board of a mobile telephone, mobile telephone manufacturers now frequently obtain different types of display modules (along with different display module controllers) produced by various manufacturers in order not to be dependent on individual display module manufacturers. In order nonetheless to ensure efficient mass production of the mobile telephones, one type of unit of the mobile telephone is basically able to address each of the various types of display modules or display module controllers via the interface to the unit. However, this requires knowledge in the unit about the type of display module or display module controller.

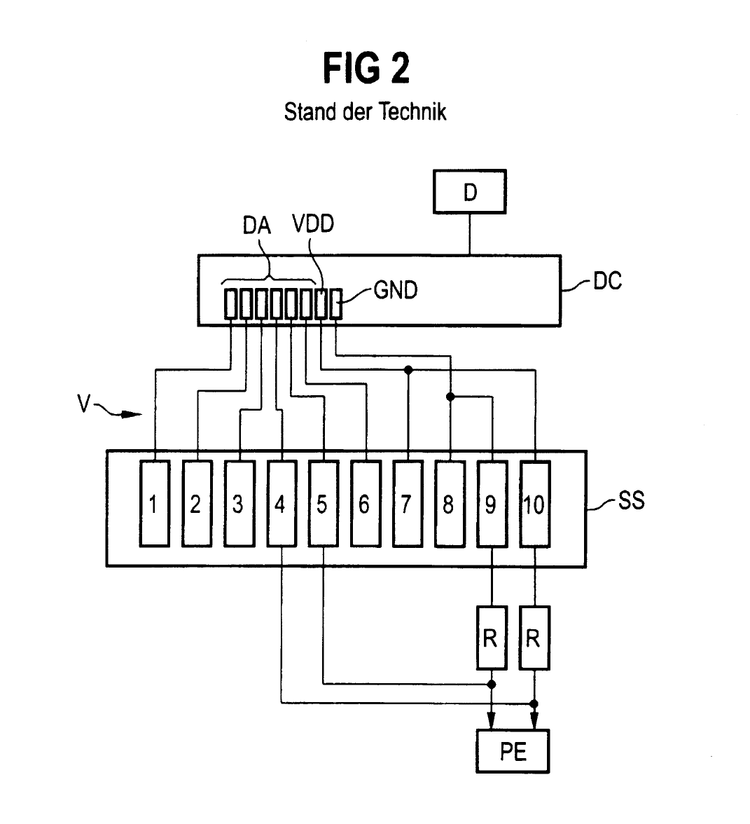

For the purpose of signaling the type of display module or display module controller to the unit or a processor of the unit of the mobile telephone, it is known—as shown in FIG. 2—how, by means of separate coding terminals 9, 10 of the interface SS to the unit, which are connected via coding lines to data inputs of a processor PE, to apply supply voltage VDD,7 or ground GND,8, depending on the type of display module or module controller, to data inputs of the processor PE of the unit prior to actual driving of the display module. Alongside the coding terminals 9, 10, the interface SS contains a supply voltage terminal 7 and a ground terminal 8, and also data terminals 1-6, which are connected via a suitable multiplicity of connecting lines V to the corresponding terminals VDD, GND, DA of the display controller DC. The coding terminals 9, 10 are decoupled by decoupling resistors R on the unit from the corresponding data terminals 4, 5 of the interface SS, which are also connected via data lines to the above data inputs of the processor, in order to facilitate shared use of data inputs of the processor PE for the coding terminals 9, 10 and the data terminals 4, 5. For the sake of simplification, the other lines from the interface SS to the processor are not shown. In the initializing mode, the data inputs of the processor PE are switched as inputs and hence to high resistance (>MOhm). The data inputs of the display controller are deactivated during this phase and so are also switched to high resistance. As a result, the required potential—ground or supply voltage, depending on the type of display module and assigned coding—is set at the corresponding data inputs of the processor PE owing to the decoupling resistors R (pull-up/pull-down resistors) (approx. 100 kOhm). This potential can be interrogated at the data inputs of the processor PE by the processor PE and used for decoding or recognizing the type of display module.

After the type of display module has been recognized, the data inputs of the processor PE are switched to the data mode, and hence to low resistance (a few kOhm), and the potentials at the data terminals 4, 5 of the interface SS are thus determined by the signals from the processor PE. The decoupling resistors R can be ignored in this operating mode.

Signaling of the type of display module or display module controller accordingly requires the additional components: decoupling resistors, coding terminals.

The object of the invention is therefore to provide a display module which facilitates signaling of the type of display module to a unit with fewer components compared to the prior art.

This object is achieved by means of the features of the independent claims. Advantageous and practical developments ensue from the dependent claims.

According to the invention, at least one decoupling resistor is switched into at least one connecting line between the display controller and the interface to the unit instead of switching it between the processor and the interface of the unit.

This allows the data terminals (4, 5) to be used in the initializing mode as coding terminals, thus obviating the need for coding terminals (9, 10) specially provided for this purpose. The number of interface terminals can thereby be reduced.

In a preferred development of the invention the multiplicity of connecting lines between the display controller and an interface to a unit is implemented at least partially by means of a Chip-on-Glass technology and at least one decoupling resistor is implemented as a line resistor of a connecting line implemented by means of Chip-on-Glass technology.

This has the advantage of being able to dispense with decoupling resistors implemented as components.

As Chip-on-Glass technology, where line resistance is known to be capable of being influenced by the geometry of the line, is sufficiently familiar to specialists both as such and from its application in display units, it will not be dealt with further here.

The invention is explained in more detail below with the aid of preferred exemplary embodiments; the figures listed here will assist in this.

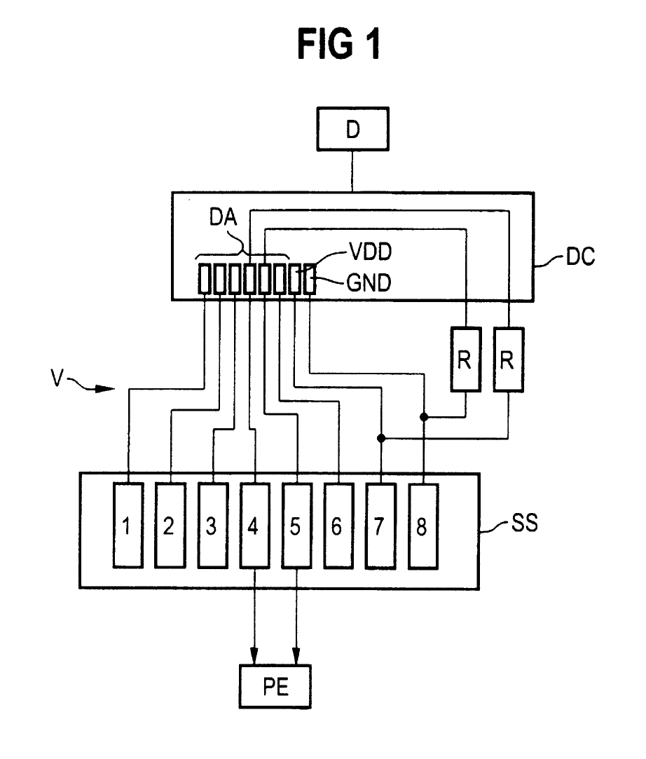

FIG. 1 shows a schematic representation of a connection between the display controller and processor of a unit;

FIG. 2 shows a schematic representation of a conventional connection between the display controller and processor of a unit.

FIG. 1 shows a display module (display D, display controller DC, connecting lines V to an interface SS) with two decoupling resistors R, which are switched into connecting lines V between the display controller DC and the interface SS to a unit, wherein coding of the type of display module is implemented by connecting the decoupling resistors R to the ground terminal 8 or the supply voltage terminal 7 of the interface SS to the unit.

Apart from the supply voltage terminal 7 and the ground terminal 8, the interface SS contains data terminals 1-6 which are connected via a suitable multiplicity of connecting lines V to the corresponding terminals (data terminals DA, ground terminal GDN, and supply voltage terminal VDD) of the display controller DC. The supply voltage terminal 7, VDD and the ground terminal 8, GND are therefore decoupled via the decoupling resistors R in corresponding connecting lines from the corresponding data terminals 4, 5 of the interface SS, which are connected via data lines to data inputs of the processor, in order to facilitate shared use of data inputs of the processor PE and shared use of terminals 4, 5 of the interface SS. For this, the data terminals DA of the display controller DC, which are connected via a decoupling resistor R to the ground terminal 8 or to the supply voltage terminal 7 of the interface SS to the unit, are also connected to a data terminal 4, 5 of the interface SS to the unit, which is in turn connected to data inputs of a processor PE of the unit. For the sake of simplification, the other lines from the interface SS to the processor are not shown.

For the purpose of signaling the type of display module or display module controller, the decoupling resistors R are switched in the initializing mode (prior to actual driving of the display module)—depending on the type of display module and assigned coding—between the ground terminal 8 or the supply voltage terminal 7 of the interface SS to the unit and data terminals DA of the display controller DC. In the present example one decoupling resistor is connected to ground and the other is connected to the supply voltage. For coding another type of display module, both or further decoupling resistors could be connected to ground, for example.

In the initializing mode, the data inputs of the processor PE are switched as inputs and hence to high resistance (>MOhm). The data inputs of the display controller are deactivated during this phase and hence also switched to high resistance. The required potential—ground or supply voltage, depending on the type of display module and assigned coding—is consequently set on the corresponding data inputs of the processor PE owing to the decoupling resistors (pull-up/pull-down resistors) (approx. 100 kOhm). This potential can be interrogated at the processor inputs by the processor PE and used for recognizing the type of display module.

After the type of display module has been recognized, the data inputs of the processor PE are switched to the data mode, and hence to low resistance (a few kOhm), so the potentials at the data terminals 4, 5 of the interface SS are determined by the signals from the processor PE. The decoupling resistors can be ignored in this operating mode.

According to one embodiment of the invention, the connecting lines V between the display controller DC and the interface SS to the unit are implemented as a flexible line into which the decoupling resistors R are switched.

According to another embodiment of the invention, the multiplicity of connecting lines V between the display controller DC and the interface SS to the unit is at least partially implemented by means of a Chip-on-Glass technology, with the decoupling resistors R being implemented as line resistors of connecting lines implemented by means of Chip-on-Glass technology.

1. Display module
with a display (D),
with a display controller (DC) for driving the display (D),
with a multiplicity of connecting lines (V) between the display controller (DC) and an interface (SS) to a unit, and
with at least one decoupling resistor (R) which is switched into at least one connecting line (V) between the display controller (DC) and the interface (SS) to a unit.

2. Display module according to claim 1
wherein the display controller (DC) has a multiplicity of data terminals (DA), a ground terminal (MA), and a supply voltage terminal (VDD),
wherein the interface (SS) to the unit has a multiplicity of data terminals (1-6), a ground terminal (8), and a supply voltage terminal (7), and
wherein at least one decoupling resistor (R) is switched between a ground terminal (8) or a supply voltage terminal (7) of the interface (SS) to the unit and a data terminal (DA) of the display controller (DC).

3. Display module according to claim 2
wherein at least one data terminal (DA) of the display controller (DC), which is connected via a decoupling resistor (R) to the ground terminal (8) or the supply voltage terminal (7) of the interface (SS) to the unit, is also connected to a data terminal (4, 5) of the interface (SS) to the unit.

4. Display module according to one of the preceding claims
wherein the multiplicity of connecting lines (V) between the display controller (DC) and an interface (SS) to a unit is implemented at least partially by means of a Chip-on-Glass technology, and
wherein at least one decoupling resistor (R) is implemented as a line resistor of a connecting line implemented by means of Chip-on-Glass technology.

5. Display module according to one of the preceding claims
wherein coding of the type of display module is implemented by the connection of at least one decoupling resistor (R) to the ground terminal (8) or the supply voltage terminal (7) of the interface (SS) to the unit.
